(19) United States
(12) Patent Application Publication
(10) Pub. No.: US 2005/0197438 A1
(43) Pub. Date: Sep. 8, 2005

(54) Polymer compositions with improved mechanical properties

(76) Inventors: Yves Bomal, Levallois-Perret (FR); Jean-Pierre Marchand, Lyon (FR); Gilles Crange, Soicy Sous Montmorency (FR); Didier Tupinier, La Courneuve (FR); Joel Varlet, Dardilly (FR)

Correspondence Address: Rhodia Inc., CN 7500, 259 Prospect Plains Road, CRANBURY, NJ, 08512, US

(21) Appl. No.: 11/108,968

(22) Filed: Apr. 19, 2005

Related U.S. Application Data
(63) Continuation of application No. 10/312,657, filed on Jul. 17, 2003, now abandoned.

(30) Foreign Application Priority Data
Jul. 3, 2000 (FR) 00/08634

(51) Int. Cl. C08K 3/26; C08K 3/34; C08K 3/22

(52) U.S. Cl. 524/425; 524/492; 524/442; 524/497

(57) ABSTRACT

The invention concerns thermoplastic materials with improved mechanical properties, comprising a matrix and inclusions. The materials comprise at least two families of inclusions defined by their type, shape and dimensions and optionally by their concentration. The materials can in particular be used for making molded thermoplastic articles.

The invention relates to thermoplastics having improved mechanical properties, comprising a matrix and inclusions. These thermoplastics may be used especially for the production of moulded thermoplastic articles.

The mechanical and thermomechanical properties of a material are essential parameters for the design of manufactured articles. In order to give a material the best possible properties, it is often sought to modify it using suitably chosen additives or fillers. This technique is used in particular for the production of thermoplastics.

It is known to use elastomers dispersed in a matrix in the form of inclusions in order to improve the impact strength of a thermoplastic. The addition of such compounds reduces the modulus of the compositions. In general, elastomers are used which are intrinsically compatible with the matrix, or compatibilized either by the grafting of functional groups onto the elastomer or by using a compatibilizer.

The mechanisms of reinforcing polymers by elastomers have been described for example by Wu (J. Appl. Pol. Sci. Vol. 35, 549-561, 1988) and then by Bartczac (Polymer, Vol. 40, 2331-2346, 1999). These studies teach that the reinforcement is tied up with the mean distance between two elastomer inclusions and that it is therefore tied up with the size and with the concentration of the elastomer in the matrix.

The possibility of improving the impact strength of thermoplastic polymers by incorporating mineral inclusions, of a chosen size and concentration, in a matrix is also known.

It is known to use glass fibres to increase the modulus of a thermoplastic. Glass fibres are large-sized objects which considerably weaken the materials. In addition, they must be used in high concentrations, of the order of 40%. For example, polyamides containing glass fibres have a high modulus but a low elongation at break. In addition, the materials obtained have a low fatigue strength.

To improve the modulus of thermoplastics, fillers of a much smaller size than fibres have been proposed. Patent FR 1 134 479 describes compositions based on nylon-6 containing silica particles having a particle size of 17 to 200 nm. More recently, materials have been described which contain plate-like mineral particles, for example exfoliated montmorillonites (U.S. Pat. No. 4,739,007) or synthetic fluoromicas. These materials have an increased modulus but a reduced impact strength.

For a given thermoplastic, it is found that there is a compromise between the impact strength and the modulus, one of these generally being improved to the detriment of the other. Compositions reinforced by high glass fibre contents improve the compromise, but there is a reduction in the elongation at break and fatigue behaviour.

The subject of the present invention is a thermoplastic for which the compromise between toughness and modulus is greatly improved, for relatively low additive contents, and/or for which the elongation at break properties and fatigue behaviour are maintained.

For this purpose, the invention provides a thermoplastic comprising a matrix consisting of a thermoplastic polymer and inclusions dispersed in the matrix, characterized in that it includes at least two types of inclusions A and B:
inclusions A: inclusions consisting of a mineral-based or macromolecular-based material, the smallest size of the inclusions being greater than 100 nm and the mean ligamentary distance in the matrix between the inclusions being less than 1 μm;
inclusions B: inclusions consisting of a mineral-based material, chosen from the following:
   approximately spherical inclusions whose mean diameter is less than 100 nm;
   inclusions having a form factor whose small dimension is less than 100 mm; and
   structurizing inclusions consisting of a group of elementary mineral particles, the largest dimension of the elementary particles being less than 100 nm.

The inclusions are chemical compounds dispersed in the matrix so as to modify the properties thereof. They are of a different nature to that of the matrix. They may, for example, be mineral particles or macromolecular substances such as elastomers, thermosetting resins or thermoplastic resins.

The matrix preferably consists of a continuous medium within which the inclusions are incorporated. It is preferable for the inclusions to be sufficiently dispersed.

The characteristics relating to the shape and to the dimensions of the inclusions correspond to observations using transmission electron microscopy.

It is known that the presence of inclusions in a matrix can result in a modification in the impact strength and modulus properties. This modification obeys a compromise which may be represented by a master curve characteristic of the matrix. Any variation in one or other of these properties is to the detriment of the other on the master curve. Surprisingly, it has been found that the material according to the invention improves the modulus/impact strength compromise outside the master curve specific to the material constituting the matrix. Thus, it has been observed that the simultaneous presence of the two types of inclusions causes additive or synergistic effects outside the modulus/impact strength compromise master curve.

The matrix consists of a thermoplastic polymer or copolymer or a thermoplastic containing a thermoplastic polymer or copolymer. It may consist of a blend of polymers or copolymers, these possibly being compatibilized by modification, using grafting or using compatibilizers.

By way of example of suitable thermoplastics as the matrix, mention may be made of polylactones, such as poly(pivalolactone), poly(caprolactone) and polymers of the same family; polyurethanes obtained by the reaction between diisocyanates, such as 1,5-naphthalene diisocyanate, p-phenylene diisocyanate, m-phenylene diisocyanate, 2,4-toluene diisocyanate, 4,4′-diphenylmethane diisocyanate, 3,3′-dimethyl-4,4′-diphenylmethane diisocyanate, 3,3′-dimethyl-4,4′-biphenyl diisocyanate, 4,4′-biphenylisopropylidene diisocyanate, 3,3′-dimethyl-4,4′-diphenyl diisocyanate, 3,3′-dimethyl-4,4′-diphenylmethane diisocyanate, 3,3′-dimethoxy-4,4′-biphenyl diisocyanate, dianisidine diisocyanate, toluidine diisocyanate, hexamethylene diisocyanate, 4,4′-diisocyanatodiphenylmethane and compounds of the same family and linear long-chain diols, such as poly(tetramethylene adipate), poly(ethylene adipate), poly(1,4-butylene adipate), poly(ethylene succinate), poly(2,3-butylene succinate), polyether diols and compounds of the same family; polycarbonates, such as poly(methane bis[4-phenyl]-carbonate), poly(bis[4-phenyl]-1,1-ether carbonate), poly(diphenylmethane bis[4-phenyl]carbonate), poly(1,1-cyclohexane-bis[4-phenyl]carbonate) and polymers of the same family; polysulphones; polyethers; polyketones; polyamides, such as poly(4-aminobutyric acid), poly(hexamethylene adipamide), poly(6-aminohexanoic acid), poly(m-xylylene adipamide), poly(p-xylylene sebacamide), poly(2,2,2-trimethylhexamethylene terephthalamide), poly(metaphenylene isophthalamide), poly(p-phenylene terephthalamide) and polymers of the same family; polyesters, such as poly(ethylene azelate), poly(ethylene-1,5-naphthalate, poly(1,4-cyclohexanedimethylene terephthalate), poly(ethylene oxybenzoate), poly(para-hydroxybenzoate), poly(1,4-cyclohexylidene dimethylene terephthalate), poly(1,4-cyclohexylidene dimethylene terephthalate), polyethylene terephthalate, polybutylene terephthalate and polymers of the same family; poly(arylene oxides), such as poly(2,6-dimethyl-1,4-phenylene oxide), poly(2,6-diphenyl-1,4-phenylene oxide) and polymers of the same family; poly(arylene sulphides), such as poly(phenylene sulphide) and polymers of the same family; polyetherimides; vinyl polymers and their copolymers, such as polyvinyl acetate, polyvinyl alcohol and polyvinyl chloride; polyvinylbutyral, polyvinylidene chloride, ethylene/vinyl acetate copolymers and polymers of the same family; acrylic polymers, polyacrylates and their copolymers, such as polyethyl acrylate, poly(n-butyl acrylate), polymethyl methacrylate, polyethyl methacrylate, poly(n-butyl methacrylate), poly(n-propyl methacrylate), polyacrylamide, polyacrylonitrile, poly(acrylic acid), ethylene/acrylic acid copolymers, ethylene/vinyl alcohol copolymers, acrylonitrile copolymers, methyl methacrylate/styrene copolymers, ethylene/ethyl acrylate copolymers, methacrylate-butadiene-styrene copolymers, ABS and polymers of the same family; polyolefins, such as low-density polyethylene, polypropylene, low-density chlorinated polyethylene, poly(4-methyl-1-pentene), polyethylene, polystyrene and polymers of the same family; ionomers; poly(epichloro-hydrins); polyurethanes, such as products from the polymerization of diols, such as glycerol, trimethylol-propane, 1,2,6-hexanetriol, sorbitol, pentaerythritol, polyether polyols, polyester polyols and compounds of the same family, with polyisocyanates, such as 2,4-tolylene diisocyanate, 2,6-tolylene diisocyanate, 4,4′-diphenylmethane diisocyanate, 1,6-hexamethylene diisocyanate, 4,4′-dicyclohexylmethane diisocyanate and compounds of the same family; and polysulphones, such as the products resulting from the reaction between a sodium salt of 2,2-bis(4-hydroxyphenyl)propane and 4,4′-dichlorodiphenylsulphone; furan resins, such as polyfuran; cellulose-ester plastics, such as cellulose acetate, cellulose acetate-butyrate, cellulose propionate and polymers of the same family; silicones, such as poly(dimethylsiloxane), poly(dimethylsiloxane-co-phenylmethylsiloxane) and polymers of the same family; and blends of at least two of the above polymers.

Most particularly preferred among these thermoplastic polymers are polyolefins, such as polypropylene, polyethylene, high-density polyethylene, low-density polyethylene, polyamides, such as nylon-6 and nylon-6,6, PVC, PET and blends and copolymers based on these polymers.

Inclusions A are dispersed in the matrix with a mean ligamentary distance in the matrix of less than 1 μm. This distance is even more preferably less than 0.6 μm. The mean ligamentary distance in the matrix is characteristic of the distance between the ends of two inclusions. This distance λ is a statistical parameter defined on the basis of the shape of the inclusions and on the amount of inclusions present in the material. It is defined by the following formula:

$$λ = d \times [ {( \frac{Π}{6 Φ} )}^{\frac{1}{3}} - 1 ] \times exp [ {( ln σ )}^{2} ]$$

where
d is the number-equivalent mean diameter of the inclusions. The term “equivalent diameter” of a particle is understood to mean its diameter if it is spherical or approximately spherical, or the diameter that a spherical inclusion of the same mass would have;
σ=E/d, where E is the standard deviation relating to the number-average particle-diameter distribution;
φ is the volume fraction of inclusions A in the composition consisting of inclusions B and the matrix, the fraction being calculated according to the following formula:

$$Φ = \frac{( c / {ρ}_{p} )}{( c / {ρ}_{p} ) + ( 100 - c / {ρ}_{m} )}$$
where
   ρₚ is the density of the substance of which the inclusions A are composed;
   ρₘ is the density of a composition comprising the matrix and inclusions B;
   c is the weight concentration of inclusions A in the composition comprising the matrix and inclusions B.

According to one embodiment, inclusions A are obtained by dispersing, in the matrix, individual objects which maintain their size and their shape once they have been dispersed in the matrix. For example, these are particles introduced in powder or dispersion form. The equivalent mean diameter of the inclusions is taken as that of the particles before they have been dispersed in the matrix.

According to another embodiment, inclusions A are obtained by dispersing a non-individualized substance in the matrix. This may involve, for example, dispersing an elastomer in the matrix. The equivalent mean diameter of the inclusions is then determined by observation in a microscope.

Very many compounds may be chosen as inclusions A. Depending on the choice of matrix and inclusions A, the compositions are sometimes termed as compositions with hard inclusions or as compositions with soft inclusions. These two types of composition, when they also contain inclusions B, are according to the invention. The terms “hard” or “soft” depend on the modulus of the compounds of which the inclusions or the matrix are composed. A composition called a composition with “hard inclusions” may be defined as a composition for which the modulus of the inclusions is greater than that of the matrix. If the opposite is the case, the composition is said to have “soft inclusions”. These terms have no limiting effect on the scope of the invention. The compositions according to the invention may comply with one or other of the terms, or even not comply with either term if the moduli of inclusions A and of the matrix are of the same order of magnitude.

A first type of material suitable for inclusions A comprises at least one elastomer. Inclusions A may consist solely of an elastomer or consist of a material comprising, apart from an elastomer, inclusions consisting of another material. In this case, the other material included with the elastomer in inclusions A may be elastomeric or non-elastomeric.

As regards the structure of inclusions A, mention may be also made of particles having a core/shell structure, for example with a rigid core and a flexible shell or a flexible shell and a rigid core. The flexible parts are preferably elastomeric.

By way of examples of elastomers that can be used for inclusions A, by themselves or with other compounds, as explained above, mention may be made of: brominated butyl rubber, chlorinated butyl rubber, nitrile rubbers, polyurethane elastomers, fluoro-elastomers, polyester elastomers, butadiene/acrylonitrile elastomers, silicone elastomers, polybutadiene, polyisobutylene, ethylene-propylene copolymers, ethylene-propylene-diene terpolymers, sulphonated ethylene-propylene-diene terpolymers, polychloroprene, poly(2,3-dimethylbutadiene), poly(butadiene-pentadiene), chlorosulphonated polyethylenes, polysulphide elastomers, block copolymers composed of glassy or crystalline blocks, such as polystyrene, polyvinyl-toluene, poly(t-butylstyrene)polyesters and similar compounds, and of elastomer blocks, such as polybutadiene, polyisoprene, ethylene-propylene copolymers, ethylene-butylene copolymers, polyethers and similar compounds, for example polystyrene/polybutadiene/polystyrene block copolymers manufactured by Shell Chemical Company under the brand name KRATON™.

The elastomers may include grafted compounds, for example grafted by copolymerization, intended to provide functionalities so as to improve their compatibility with the matrix. The functional groups thus grafted are preferably carboxylic acids, acid derivatives and acid anhydrides. By way of example, mention may be made of ethylene-propylene rubbers (EPR) grafted with maleic anhydride, ethylene-propylene-diene monomer rubbers (EPDM) grafted with maleic anhydride, and styrene/ethylene-butadiene/styrene block copolymers grafted with maleic anhydride.

A second type of material suitable for inclusions A comprises thermoplastics.

The thermoplastic- or elastomeric-based inclusions are, for example, obtained by melt-blending the constituent material of the matrix with the constituent thermoplastic of the inclusions, these two materials not being completely miscible. The constituent material of the inclusions may include a functionalization intended to improve the compatibility with the matrix and thus control the dispersion and size of the inclusions therein. This function may also be provided by the use of a compatibilizer, for example a polymer.

A third type of compound for inclusions A consists of mineral particles. The mineral inclusions may be incorporated into the matrix, for example, by introducing them into the polymerization medium or by melt-blending, possibly via a masterbatch.

The particles may be approximately spherical or have a low form factor. They may include on their surface a treatment or coating intended to improve the dispersion in the matrix or to modify the interfacial behaviour with respect to the matrix. This may, for example, be a treatment intended to reduce the interactions between the particles.

By way of example of mineral particles that may be suitable for inclusions A, mention may be made of metal oxides, hydroxides or hydrated oxides, metal sulphides and alkali and alkaline-earth metal carbonates. The mineral particles may more-particularly be chosen from particles based on silica or titanium oxide, these possibly being coated, alumina, calcium carbonate, barium sulphate, zinc sulphide and kaolin of very small particle size.

By way of example, the calcium carbonate particles are preferably treated with a compound comprising a long-chain carboxylic acid, for example stearic acid or alkali or alkaline-earth metal stearates.

The mineral particles used for inclusions A advantageously have a uniform size distribution. Preferably, the particles are approximately spherical with a mean diameter greater than 0.1 μm.

The mineral particles used for inclusions A advantageously have a mean size of between 0.2 μm and 2 μm.

By way of examples of matrix/inclusions A pairs that can be used, mention may be made of:
polyamide/elastomer systems, the elastomer advantageously being an EPR or an EPDM, this preferably being grafted with maleic anhydride;
polypropylene/calcium carbonate systems, the calcium carbonate being treated with stearic acid;
polyethylene/CaCO₃ systems;
polyamide/CaCO₃ systems;
high-impact polystyrenes (HIPS);
polystyrene/elastomer systems;
thermoplastic alloys, such as polyamide/polypropylene and polyamide/PPO alloys;
polyamide/kaolin systems, the kaolin having a small particle size;
PVC/core-shell particle systems, the core of the particles being a styrene-acrylic polymer and the shell being based on PMMA.

The inclusions B are mineral-based objects, at least one dimension of which is less than 100 nm. They may be chosen from the inclusions known for increasing the modulus of a thermoplastic when they are dispersed in the latter. They are, for example, rigid mineral particles, the modulus of which is greater than that of the matrix.

The content of inclusions B is small compared with that of the fillers which are most commonly used to modify the modulus of materials, such as glass fibres for example. This characteristic makes it possible to reduce the amount thereof, to maintain a beneficial surface appearance or to maintain certain properties of the matrix which may be lost by using conventional fillers. In the case of polyamide matrices, the use of nanometric particles makes it possible, for example, to increase the modulus while maintaining a ductile material, having a satisfactory fatigue strength.

Inclusions B may be chosen from several families, relating to their shapes, structures and dimensions.

A first family comprises isotropic inclusions of spherical or approximately spherical shape. The diameter of these inclusions is less than 100 nm.

A second family comprises anisotropic inclusions which have a form factor. For inclusions of this family, it is possible to define at least a large dimension and a small dimension. For example, if the inclusions have a cylindrical shape the large dimension will be defined by the length of the cylinder and the small dimension will be defined by the diameter of the cross section of the cylinder. If the inclusions are in the form of platelets, the large dimension will be defined by a dimension characteristic of the length or diameter of the platelet and the small dimension will be defined by the thickness of the platelet. The form factor, defined by the ratio of the large dimension to the small dimension, may be small, for example between 1 and 10, or relatively large, for example greater than 10, possibly reaching values of the order of 100 or more. The small dimension is less than 100 nm.

A third family comprises structurizing inclusions. These inclusions consist of a group of elementary mineral particles, the largest dimension of the said elementary particles being less than 100 nm. Almost irreversible groups of particles, for example in the form of aggregates, are preferred. The precise shape of the group of elementary particles is generally undefined. Advantageously, the configuration of the group is in the form of an open structure so that the constituent material of the matrix is present in the said open structure. The group may, for example, be configured so that it defines a cavity or a concave space, the constituent material of the matrix being present in the said cavity or the said concave space.

Such groups dispersed in the matrix may be obtained from aggregates or agglomerates of a large number of elementary particles, preferably already grouped together in the form of aggregates. There may therefore be an agglomeration of aggregates. The agglomerates are partially dispersed during the process of incorporating them into the matrix or during the polymerization process resulting in the constituent polymer of the matrix, in order to result in the structurizing group of particles. Preferably, the aggregates have a size of less than 200 nm with an elementary particle size of less than 25 nm.

The concentration of mineral particles constituting inclusions B may be between 1 and 30% by weight. Preferably, it is between 5 and 10%.

As particles possibly suitable for inclusions B, mention may be made of the approximately spherical particles obtained by precipitation techniques.

Mention may be made, for example, of metal oxides and hydroxides, such as silica, titanium dioxide and zirconium dioxide. The silicas used may, for example, have been obtained by precipitation from alkali metal silicates, with controlled isotropic growth. Mention may be made, for example, of the silica sols sold by Clariant under the name KLEBOSOL.

As particles possibly suitable for inclusions B, mention may also be made of the groups of silica particles obtained by dispersion in the matrix or agglomerates of silica particles. These agglomerates are, for example, obtained by a silica synthesis process called “precipitation”.

Finally, as particles possibly suitable for inclusions B, mention may be made of particles having a small or high form factor or particles obtained by exfoliation, dissociation or delamination of compounds having a sheet-like morphology.

By way of example, mention may be made of fluoromicas, hydrotalcites, zirconium phosphates and silica platelets.

As silica platelets suitable for implementing the invention, mention may be made of montmorillonites, smectites, illites, sepiolites, palygorkites, muscovites, allervardites, amesites, hectorites, talcs, fluorohectorites, saponites, beidellites, nontronites, stevensites, bentonites, micas, fluoromicas, vermicullites, fluorovermicullites and halloysites. These compounds may be of natural, synthetic or modified-natural origin.

The exfoliation or dissociation of the platelets may be favoured by a pretreatment using an organic compound, for example an organic compound allowing the interplatelet distance to be increased. By way of example, mention may be made of ioniums, that is to say substituted phosphoniums or ammoniums.

To implement the invention, the material comprises, for example, the following metal/inclusions B pairs:
polyamide/phyllosilicate platelets, for example exfoliated montmorillonite;
polypropylene/silica;
polystyrene/exfoliated montmorillonite;
polyamide/fluoromicas;
polyamide/zirconium phosphates.

The material according to the invention may also include additives or adjuvants such as lubricants, plasticizers, stabilizers, such as heat or light stabilizers, compounds used for catalyzing the synthesis of the matrix, antioxidants, fire retardants, antistatic agents and bioactive compounds. The nature of the additives used generally depends on the matrix.

According to a first preferred embodiment of the invention, the matrix is based on polypropylene, inclusions A are based on calcium carbonate and inclusions B are based on silica in the form of groups of elementary particles.

The calcium carbonate particles are advantageously treated with stearic acid. The calcium carbonate may be obtained by precipitation or by grinding natural calcium carbonate.

Inclusions A according to this embodiment have a number-average size of between 0.3 and 3 μm, preferably between 0.3 and 0.9 μm. The proportion by weight of these inclusions in the material is preferably less than 25%.

The concentration of calcium carbonate particles is preferably chosen so that the mean ligamentary distance is less than 0.6 μm.

The silica is present in the matrix with a concentration by weight of between 1% and 20%, preferably less than 5%. Advantageously, the silica is dispersed in the matrix in the form of aggregates of elementary particles, with an aggregate size of less than 200 nm and an elementary particle size of less than 25 nm.

By way of example, mention may be made of the dispersible silicas sold by Rhodia under the brand names TIXOSIL NM61 and TIXOSIL 365.

The particles based on silica and based on calcium carbonate are incorporated into the matrix by melt blending, for example using an extrusion device. According to a preferred characteristic, the extrusion is carried out with high shear, for example using a twin-screw extruder.

According to a second preferred embodiment of the invention, the matrix is based on a polyamide, inclusions A are mineral particles based on a metal oxide and inclusions B are mineral particles having a relatively high form factor.

Inclusions A are advantageously based on silica. These are, for example, approximately spherical silicas of the Stöber type, the size dispersion of which is small. Mention may be made, for example, of the silicas sold under the reference SEOSTAR KEP50 by Nippon Shokubai. Advantageously, the particles are incorporated into the matrix by an extrusion operation.

The particles advantageously have a mean diameter of between 0.1 μm and 0.7 μm. Preferably the diameter is between 0.3 μm and 0.6 μm and even more preferably approximately equal to 0.5 μm.

The weight proportion of inclusions A in the polyamide matrix is advantageously between 5% and 20%.

According to the second preferred embodiment of the invention, inclusions B are mineral particles of nanometric size.

A first family of particles for inclusions B according to the second preferred embodiment consists of approximately spherical particles of mean diameter less than or equal to 100 nanometres. According to a preferred embodiment, the mean diameter of these particles is less than or equal to 50 nanometres.

The particles may be obtained from a natural source or may be synthesized. As examples of suitable materials, mention may be made of metal, for example silicon, zirconium, titanium, cadmium and zinc, oxides and sulphides. Silica-based particles may in particular be used.

The particles may have been subjected to treatments for making them compatible with the matrix. For example, these treatments are surface treatments or a surface coating with a compound different from that constituting the core of the particles. Treatments and coatings may likewise be used to favour dispersion of the particles, either in the matrix polymerization medium or in the polymer melt.

The surface of the particles may include a protective layer intended to prevent any possible degradation of the polymer when it comes into contact with them. Metal oxides, for example silica, as a continuous or discontinuous layer may thus be deposited on the surface of the particles.

Any method allowing particles to be dispersed in a resin may be used to implement the invention. A first process consists in mixing the particles in the molten resin and possibly subjecting the mixture to a high shear, for example in a twin-screw extruder, so as to achieve good dispersion. Another process consists in mixing the particles with the monomers in the polymerization medium and then in polymerizing the resin. Another process consists in mixing, into the molten resin, a concentrated mixture of resin and particles, which is prepared for example using one of the processes described above.

A second family of particles for inclusions B according to the second preferred embodiment consists of particles in the form of platelets having a thickness of less than 10 nanometres. Preferably, the thickness is less than 5 nanometres. The particles are preferably dispersed in the matrix in their individual form.

Advantageously, the platelets are obtained from silicates in the form of exfoliable sheets. The exfoliation may be favoured by a pretreatment using a swelling agent, for example by exchange of cations initially contained in the silicates with organic cations, such as oniums. The organic cations may be chosen from phosphoniums and ammoniums, for example primary to quaternary ammoniums. Mention may be made, for example, of protonated amino acids, such as 12-aminododecanoic acid protonated as ammonium, protonated primary to tertiary amines and quaternary ammoniums. The chains attached to the nitrogen or phosphorous atom of the onium may be aliphatic, aromatic or arylaliphatic, may be linear or branched and may have oxygen-containing units, for example hydroxy or ethoxy units. By way of example of ammonium organic treatments, mention may be made of dodecylammonium, octadecylammonium, bis(2-hydroxyethyl) octadecylmethylammonium, dimethyldioctadecylammonium, octadecylbenzyldimethylammonium and tetramethylammonium treatments. By way of example of phosphonium organic treatments, mention may be made of alkyl phosphonium treatments such as tetrabutyl phosphonium, trioctyloctadecyl phosphonium and octadecyltriphenyl phosphonium treatments. These lists are in no way limiting in character.

The sheet-like silicates suitable for implementing the invention may be chosen from montmorillonites, smectites, illites, sepiolites, palygorkites, muscovites, allervardites, amesites, hectorites, talcs, fluorohectorites, saponites, beidellites, nontronites, stevensites, bentonites, micas, fluoromicas, vermicullites, fluorovermicullites and halloysites. These compounds may be of natural, synthetic or modified-natural origin.

According to a preferred embodiment of the invention, the compositions are composed of a polyamide resin and of platelike particles dispersed in the resin, these particles being obtained by the exfoliation of a phyllosilicate, for example a montmorillonite which has been subjected beforehand to a swelling treatment by ion exchange. Examples of swelling treatments that can be used are, for example, described in Patent EP 0 398 551. Any of the known treatments for favouring exfoliation of phyllosilicates in a polymer matrix may be used. For example, a clay treated with an organic compound sold by Laporte under the brand name CLOISITE® may be used.

Any method for obtaining a dispersion of particles in a resin may be used to implement the invention. A first process consists in mixing the compound to be dispersed, possibly treated for example with a swelling agent, in the molten resin and in possibly subjecting the mixture to high shear, for example in a twin-screw extruder, so as to achieve good dispersion. Another process consists in mixing the compound to be dispersed, possibly treated for example with a swelling agent, into the monomers in the polymerization medium and then in polymerizing the resin. Another process consists in mixing into the molten resin a concentrated mixture of a resin and dispersed particles, which is prepared, for example, using one of the processes described above.

To obtain dispersions of inclusions in a matrix, it is possible to use a product for which the inclusions have already been individualized, for example a powder having a particle size substantially identical to that of the inclusions in the matrix or a dispersion in the liquid medium or a masterbatch. It is also possible to use a product which is a precursor of the inclusions or a combination of products, that is to say a product or products which will form inclusions in their definitive nature, size and shape during the incorporation processes.

Principally, two types of process are known which allow dispersions of inclusions in the matrix to be obtained from a product constituting the inclusions or from a precursor.

Processes of the first type are called incorporation-by-synthesis processes. Briefly, these processes consist in incorporating the inclusions or a precursor of the inclusions into the polymerization medium, before polymerization. The term “polymerization medium” is understood to mean a medium containing the precursor monomers or oligomers of the polymer. Such a process may be particularly well suited to incorporating a compound in the form of a dispersion in a liquid. It is more particularly suitable for incorporating mineral compounds.

Processes of the second type are called incorporation-by-melt-mixing processes. Briefly, these processes consist in mixing the inclusions or a precursor of the inclusions with the material constituting the matrix, in the melt. The mixing must be carried out so that there is sufficient dispersion of the inclusions in the matrix. The shear observed during the mixing operation may be relatively high.

The incorporation-by-melt-mixing processes may be carried out using extruders. Such extruders may furthermore allow the shear to be controlled. By way of example, mention may be made of single-screw extruders and twin-screw extruders.

The compound incorporated by melt mixing, constituting the inclusions or the precursor of the inclusions, may be presented in the form of a powder, a dispersion in a liquid, granules or a masterbatch in a polymer of the same type as the matrix.

As explained above, the melt-mixing process may be preferred for incorporating inclusions consisting of an elastomeric or thermoplastic material. Such inclusions may be obtained by mixing, using an extruder, the material constituting the matrix presented in the form of granules, with a powder or granules of the material constituting one type of inclusion. In order to obtain the desired dispersion and size of inclusions, it may be necessary to use a compatibilization system in the form of comonomers in the material or of one or more compounds incorporated into the composition during the mixing phase. It is common practice, for example, to functionalize an elastomer with maleic anhydride or to incorporate, during an extrusion phase, maleic anhydride or a polymer containing maleic anhydride units. Such operations are known to those skilled in the art. This technique may, in particular, be used to obtain inclusions of type A.

The materials according to the invention may be obtained by several processes. The choice of process for obtaining the compositions may depend on the nature of the inclusions to be obtained, on their initial shape and on the matrix chosen.

According to a first process, two types of inclusion are incorporated using melt-mixing operations. According to a first method of implementation, inclusions A and B or their precursors are incorporated during the same mixing phase. According to a second method of implementation, each type of inclusion is incorporated in succession during two separate extrusion operations.

According to a second process, the two types of inclusion are incorporated using incorporation-by-synthesis operations. By means of this process, the inclusions or precursor of the two types are incorporated into the polymerization medium, before the polymerization is carried out. The two types of inclusion may be incorporated in succession or at the same time, in identical or different forms.

According to a third process, the two types of inclusion are incorporated using an incorporation-by-synthesis process and then using a melt-mixing process, respectively. By means of such a process, the A-type inclusions are dispersed using incorporation by synthesis and then the B-type inclusions are dispersed using melt mixing, or vice versa.

Further details or advantages of the invention will become more clearly apparent in the light of the following examples given solely by way of indication.

### EXAMPLES 1 TO 5

### Raw Materials

Polypropylene: ELTEX HV P 001P polypropylene in powder form (from Solvay);
Antioxidant: IRGANOX B225;
Calcium carbonate: stearate-treated 95T-grade CaCO₃ (from Omya)
Silica: TIXOSIL NM61 silica (from Rhodia).
   The antioxidant is used in an amount of 0.2% by weight (with respect to the polymer).

### EXAMPLES 1 TO 5

### Processing/Forming

The raw materials were mixed in the proportions by weight indicated in Table I in an internal mixer (Brabender) at a set temperature of 180° C.

After cooling, the product was granulated and then formed by compression moulding (180° C./360 bar/1 minute and cooling under pressure at 200° C./minute).

The final material was obtained in the form of plaques 4 mm in thickness.

TABLE I

| | | | Compara- | Compara- | Compara- |
|---|---|---|---|---|---|
| | | | tive | tive | tive |
| | Example | Example | Example | Example | Example |
| | 1 | 2 | 3 | 4 | 5 |
| Polypropyl- | 93% | 91% | 100% | 95% | 98% |
| ene + | | | | | |
| antioxidant | | | | | |
| (vol %) | | | | | |
| CaCO₃ | 5% | 5% | / | 5% | / |
| (vol %) | | | | | |
| Silica | 2% | 4% | / | / | 2% |
| (vol %) | | | | | |

### EXAMPLES 1 TO 5

### Mechanical Properties

The mechanical properties were measured at room temperature (23° C.), either under quasi-static conditions (1 mm/min) or under dynamic conditions (1 m/s).

The elastic modulus E and the yield stress σ_{y} were determined by tensile tests on dumbbell test specimens at 1 mm/min.

The toughness was measured in quasi-static mode at 1 mm/min by testing on a CT-type specimen (40×40×4). Since the fracture behaviour was non-linear, it was not possible to use the criteria of Linear Fracture Mechanics.

The fracture behaviour was therefore evaluated through the fracture energy J and more particularly the curve representing the energy dissipated by the material during propagation of the damage, namely the J versus Δa curve.

The protocol used for this measurement is described in the ASTM E813 standard.

From the J versus Δa curve, an initiation criterion (J_{c}) and a propagation criterion equal to the slope dJ/dΔa at the point J_{c} are defined. The value of J_{c} is taken for Δa=0.2 mm, in accordance with the ESIS recommendations.

The impact strength was measured at 1 m/s by tests on a notched bending specimen (Charpy type) using an instrumented vertical impact device. The procedure used is in accordance with the ESIS/TC4 recommendations.

The results in quasi-static mode are summarized in Table II.

TABLE II

| | E | σ_{y} | J_{c} | dJ/dΔa |
|---|---|---|---|---|
| Example | (MPa) | (MPa) | (kJ/m²) | (10³kJ/m³) |
| 1 | 1700 | 28 | 20 | 37 |
| 2 | 1600 | 33 | 30 | 65 |
| 3 | 1350 | 28 | 12 | 15 |
| 4 | 1450 | 25.5 | 21 | 40 |
| 5 | 1700 | 28 | 11 | 11 |

Surprisingly, when the silica content is increased (from 2% to >4%), the modulus does not increase but there is a great improvement in the toughness (J_{c} increases by 50% and dJ/dΔa increases by more than 75%).

The results in dynamic mode are given in Table III.

TABLE III

| | J_{c} | dJ/dΔa |
|---|---|---|
| Example | (kJ/m²) | (10³kJ/m³) |
| 1 | 5 | 8.25 |
| 3 | 1.25 | 2.75 |
| 4 | 4 | 7 |
| 5 | 1 | 0.8 |

In dynamic mode, the measured energy levels are much lower than those obtained in static mode.

However, the differences between unfilled material and filled material are again observed.

### EXAMPLES 6 TO 10

### Raw Materials

Polyamide: nylon-6 produced by Rhodia, having a relative viscosity index in formic acid (9% concentration at 25° C.) of 150 ml/g;
Silica 1: spherical silica supplied by Nippon Shokubai Co. under the reference SEHOSTAR KE-P-50, having a mean diameter of 0.53 μm (number-average diameter determined by SEM image analysis with an accuracy of 0.05 μm);
Silica 2: spherical silica supplied by Nippon Shokubai Co. under the reference SEHOSTAR KE-P-100, having a mean diameter of 1 μm (number-average diameter determined by SEM image analysis, with an accuracy of 0.1 μm);
Clay: treated montmorillonite supplied by Laporte under the reference SCPX 1353, having been subjected beforehand to an ion exchange with dimethyldioctadecylammonium methyl sulphate in an amount of 120 milliequivalents per 100 g.

### EXAMPLES 6 TO 10

### Processing/Forming

The process for producing the compounds was split into two steps:
5% by weight of clay was incorporated into the polyamide by mixing in a Leistritz twin-screw extruder having a diameter of 34 mm at a temperature of 250° C. The polyamide granules used were predried for 16 h at 80° C. in a low vacuum, the mixture obtained being denoted by M;
10% by weight of silica 1 or silica 2 with respect to the mixture M was incorporated in a second pass through the extruder and the material output by the extruder was granulated. In order to avoid having to vent volatiles during incorporation of the silica in the extruder, the powder was predried for 16 h at 80° C. in a low vacuum. The mixture M underwent the same predrying treatment.
   By examining the granules obtained using a transmission electron microscope, it was confirmed that this process resulted in a homogeneous distribution of both types of particle.

The proportions by weight of the various materials produced are given in Table IV.

TABLE IV

| | | | Compara- | Compara- | Compara- |
|---|---|---|---|---|---|
| | | | tive | tive | tive |
| | Example | Example | Example | Example | Example |
| | 6 | 7 | 8 | 9 | 10 |
| Polyamide | 85% | 85% | 90% | 95% | 100% |
| Silica 1 | 10% | / | 10% | / | / |
| Silica 2 | / | 10% | / | / | / |
| Clay | 5% | 5% | / | 5% | / |

### EXAMPLES 6 TO 10

### Mechanical Properties

The mechanical properties of the specimens obtained in granule form were evaluated according to the following protocol:

After drying the granules for 16 h at 80° C. in a low vacuum, dumbbell test specimens (ISO 3167 standard: multi-use test specimens) were produced using a DEMAG 80-200 moulding press (mould temperature-controlled at 80° C., temperature profile between the feed zone and the injection nozzle staged between 230° C. and 260° C.).

After having cut the central part of the test specimens and obtained strips having the dimensions of 80×10×4 mm, the following properties were measured:
Charpy notched impact strength (ISO 179/1eA standard);
flexural modulus at a strain of 0.3% and a frequency of 1 Hz between 0° C. and 200° C. (RSA II tensile tester from Rheometrics).
   The mechanical properties were measured on test specimens conditioned at 50% RH (accelerated conditioning according to the ISO 1110 standard: 14 days' residence in an oven environmentally controlled at 70° C. and 62% RH).

The results are given in Table V.

TABLE V

| | Charpy | Flexural | Water up- | |
|---|---|---|---|---|
| | impact | modulus at | take by | |
| | strength | 23° C./50% | weight | Mean liga- |
| | at 50% RH | RH | (ISO 1110 | mentary |
| | (kJ/m²) | (GPa) | standard) | distance |
| Example 6 | 51.4 | 2.1 | 2.57% | 0.56 |
| Example 7 | 19.5 | 2.1 | 3.00% | 1.05 |
| Comparative | NB** | 1.1 | | 0.56 |
| Example 8 | | | | |
| Comparative | 19.2 | 1.93 | 2.70% | Not |
| Example 9 | | | | applicable |
| Comparative | 80 | 1.0 | | Not |
| Example 10 | | | | applicable |

*the calculation was made by considering that:
σ = 1 (monodisperse particles);
ρₚ = 1.95 g/cm³ (density of the silica particles);
ρₘ = 1.13 g/cm³ (density of the material containing only clay and nylon-6, or only nylon-6: granules obtained in Comparison 9 and Comparison 10, respectively).
**incomplete fracture of the specimen during the impact strength test.

1-43. (canceled)

44. A thermoplastic comprising a matrix consisting of a thermoplastic polymer and inclusions dispersed in the matrix, said inclusions being of at least two types A and B:
inclusions A consisting of a mineral-based or macromolecular-based material, said inclusions having a smallest size greater than 100 nm and a mean ligamentary distance in the matrix between the inclusions being less than 1 μm, optionally, less than 0.6 μm;
inclusions B consisting of a mineral-based material, which are:
approximately spherical inclusions whose mean diameter is less than 100 nm;
inclusions having a form factor whose small dimension is less than 100 nm; or
structurizing inclusions consisting of a group of elementary mineral particles, whose largest dimensions of said elementary particles being less than 100 nm.

45. The thermoplastic composition according to claim 44, wherein the inclusions A is an elastomer.

46. The thermoplastic composition according to claim 45, wherein the inclusions A consist only of an elastomer.

47. The thermoplastic composition according to claim 45, wherein the inclusions A is an elastomer comprising inclusions consisting of another material, which is elastomeric or non-elastomeric.

48. The thermoplastic composition according to claim 47, wherein the inclusions A further have a core/shell structure, the core consisting of a rigid or flexible material and the shell consisting of a rigid material if the core consists of a flexible material, and of a flexible material if the core consists of a rigid material.

49. The thermoplastic composition according to claim 46, wherein the inclusions A consist of a thermoplastic.

50. The thermoplastic composition according to claim 44, wherein the mineral based material of inclusions A are mineral particles.

51. The thermoplastic composition according to claim 50, wherein the inclusions A have a mean size of between 0.2 μm and 2 μm, have a surface treatment capable of improving their dispersion in the matrix, and the mineral particles are based on silica, titanium dioxide, calcium carbonate, optionally treated with stearic acid or alumina.

52. The thermoplastic composition according to claim 44, wherein the inclusions A have a mean size of greater than 0.1 μm and the inclusions A have a concentration by weight with respect to the entire composition of less than 20%.

53. The thermoplastic composition according to claim 44, wherein the material based of inclusions B are mineral particles, having a concentration by weight of between 1 and 40%, optionally between 5 and 20%, with respect to the weight of the entire composition.

54. The thermoplastic composition according to claim 44, wherein the material based of inclusions B are colloidal fillers.

55. The thermoplastic composition according to claim 44, wherein the inclusions B are obtained by the precipitation of metal oxides or sulphides.

56. The thermoplastic composition according to claim 44, wherein the inclusions B are particles based on silica, zirconium dioxide, titanium dioxide or alumina, said particles being in the form of platelets whose thickness is less than 20 nm.

57. The thermoplastic composition according to claim 56, wherein the particles are particles obtained by total or partial exfoliation of platelet-like silicates, fluoromicas, hydrotalcites or zirconium phosphates.

58. The thermoplastic composition according to claim 44, wherein the inclusions B are acicular in shape.

59. The thermoplastic composition according to claim 44, wherein the matrix is based on polyolefins, polyamides, polyesters, polycarbonates, polyacetals, acrylic polymers, methacrylic polymers, styrene polymers, vinyl polymers, or polyvinyl chloride.

60. The thermoplastic composition according to claim 59, wherein the matrix is based on polypropylene, the inclusions A are calcium carbonate particles whose surface has been treated with stearic acid, said inclusions having a mean size of between 0.3 μm and 2 μm.

61. The thermoplastic composition according to claim 60, wherein the inclusions B are structurizing inclusions consisting of an aggregate of silica particles, the size of the silica particles in the aggregate being less than 26 nm; and
said inclusions B have a concentration by weight of less than 5%, with respect to the weight of the entire composition.

62. The thermoplastic composition according to claim 44, wherein the matrix is based on a polyamide, and the inclusions B are obtained by an exfoliation of a clay, optionally a montmorillonite, that have optionally undergone a treatment by an organic molecule so as to favour said exfoliation.

63. The thermoplastic composition according to claim 62, wherein the inclusions B are approximately spherical silica particles having a diameter of less than 100 nm.

64. The thermoplastic composition according to claim 62, wherein the inclusions A are based on silica, having a mean diameter of between 0.3 and 1 μm, optionally between 0.4 and 0.6 μm.

65. A process for manufacturing compositions as defined in claim 44, wherein the inclusions of both types are incorporated into the matrix by one or more extrusion operations.

66. The process according to claim 60, wherein the inclusions A and B are obtained by incorporating particles into a medium for manufacturing the thermoplastic matrix.

67. The process according to claim 66, wherein the inclusions A are obtained by melt-mixing with an extruder for extruding the matrix or of a composition comprising the matrix and the inclusions B, with an elastomeric or thermoplastic compound under conditions such that said compound is dispersed as inclusions in said matrix or said composition.

68. The process according to claim 67, wherein the thermoplastic or elastomeric compound includes functionalities for compatibilization with the matrix or a compatibilization compound is added during the melt-mixing phase.

69. The process according to claim 66, wherein the inclusions are incorporated into the matrix by extrusion in the form of a masterbatch.
